(19) United States
(12) Patent Application Publication
(10) Pub. No.: US 2026/0177678 A1
(43) Pub. Date: Jun. 25, 2026

(54) Method for measuring the distance between a location and an object

(71) Applicants: Andreas Perger, Wien (AT); Leica Camera AG, Wetzlar (DE)

(72) Inventor: Andreas Perger, Wien (AT)

(21) Appl. No.: 19/367,687

(22) Filed: Oct. 23, 2025

(30) Foreign Application Priority Data
Oct. 24, 2024 (AT) A50849/2024

(51) Int. Cl. G01S 7/487; G01S 7/4865; G01S 17/10

(52) U.S. Cl. CPC G01S 7/4876; G01S 7/4865; G01S 17/10

(57) ABSTRACT

A method for measuring the distance between a location and an object is provided, in which several light pulses are emitted from the location and the light pulses reflected by the object are sampled, whereby sample values are obtained which are summarized in a sampling histogram, wherein an interference histogram is subtracted from the sampling histogram, thereby a distance histogram is obtained.

### BACKGROUND OF THE INVENTION

The invention relates to a method for measuring the distance between a location and an object, in which several light pulses are emitted from the location and the light pulses reflected by the object are sampled, whereby sample values are obtained which are summarized in a sampling histogram.

The invention further relates to a device for measuring the distance between a location and an object.

Since the 1990s, laser rangefinders based on the pulse time-of-flight method have also become widespread in the consumer sector. These are used primarily in golf and hunting, but also by sport shooters, in water sports and other recreational activities. The measuring range of such rangefinders is a few hundred meters to a few kilometers, and the accuracy is typically around one meter, which is usually sufficient for the applications mentioned above. Targets that are not directed but reflect diffusely, such as trees and bushes, but also artificial objects, are usually appropriate. In consumer applications, it is of course important that the lasers used are eye-safe.

The price of such a product is also important and crucial for mass distribution. Therefore, it is important to ensure that the rangefinder components can be manufactured cost-effectively. Laser rangefinders for the above-mentioned applications typically consist of the electronic part (including optoelectronic components), as well as optical and mechanical parts. While the mechanical parts hold all components securely in place and protect them from external influences, the optical components (generally consisting of the objective, inversion system, and eyepiece, as well as optics for transmitting and receiving the laser radiation) serve to visualize and target the measured object. The optical system can be designed for monocular or binocular observation.

The electronic component essentially consists of a transmitter and a receiver for the laser beam, as well as a signal processing and display unit. The signal processing unit also integrates the operation, control of the display, and power supply. Additional components such as an inclinometer, compass, temperature and air pressure sensors, and the like can also be added. Laser diodes have become established as transmitters, while avalanche photodiodes (APDs) have become established as the receivers, both with associated electronic circuits. Avalanche photodiodes are diodes with an internal amplification mechanism, enabling them to detect even weak optical signals and even individual photons. Furthermore, the transmitter and receiver require optics to collimate the laser beam toward the target and to project the laser light reflected from the target onto the receiver, wherein the aforementioned observation optics can also be used if necessary. Optical components are also required to reflect the display into the observation beam path (see EP 1 069 442 B1).

As mentioned, the rangefinders described here operate according to the pulse-time-of-flight method, which means they measure the time it takes for a laser pulse to travel from the transmitter to the target and back to the receiver. For this purpose, the receiver signal is sampled and digitized after a laser pulse has been emitted, and the resulting digital data is evaluated to determine the distance to the target object.

At large distances to be measured, which can be several kilometers, the light pulses reflected from the target and hitting the receiver are very weak and can be completely lost in the unavoidable noise on the receiver side, which comes primarily from the ambient light, but also from the photodiode and the subsequent amplifier. For this reason, a process has become established in which a large number of laser pulses (usually several thousand) are emitted and the associated received signals are added synchronously. Per sampling cycle, i.e. per unit of time, the received signals are added up, so that per sampling cycle a number of individual sampling values corresponding to the number of light pulses emitted is obtained, which are added together. The useful signal resulting from the reflected laser pulses increases linearly with the number of pulses; however, for statistical reasons, the noise is only based on the root of the pulse number. The signal-to-noise ratio improved in this way makes it possible to measure distances that cannot be measured with a single pulse of the same strength. Such a method is described in detail in EP 1 078 281 B1. What is important here is that the generation of the transmission pulse and the sampling take place synchronously, which is best achieved by deriving both clock signals necessary for this from the clock signal of a microcontroller. The sample values, which are supplied by a fast A/D converter, are stored either in an external memory or directly in the RAM of the microcontroller so that they can later be subjected to the aforementioned summation. In the case of storage in an external RAM, the addresses of this memory chip are also controlled synchronously with the clock signals mentioned either by a synchronous counter or, even better, by the microcontroller itself. The sampling frequency is usually selected to be a few 10 MHz. It must not be too low in order to obtain a sufficient number of “base points” on the received signal. However, a sampling frequency that is too high has an impact on the component costs and the resulting amounts of data, which have to be processed in a short time. The position of the received pulse within this group of points called a “histogram” reflects the distance.

In the case of a sampling frequency of, for example, 25 MHz, the distance between the sampling times corresponds to a distance difference of 6 meters. If you are content with determining the position of the maximum of the received pulse within the histogram, you get a distance resolution of 6 meters. In most cases this is not satisfactory. Therefore, interpolation is used to determine, for example, the 50% point of the rising or falling edge of the pulse or the position of the center of gravity of the pulse. Further interpolation algorithms are conceivable.

As mentioned, the sampling frequency is chosen primarily for cost reasons, so that the received pulse is represented by a few sample values. There are usually around three to four sampling points that lie between the 50% points of the rising and falling edges. This allows an accuracy of around one meter to be achieved.

As already mentioned, the useful signal in the histogram grows proportionally to the number of additions, i.e. the number of laser pulses. However, the noise, which comes from the photodiode, the connected amplifier and the background light (light incident on the measurement target), only grows with the square root of the additions. This means that the signal-to-noise ratio (SNR) also increases with the square root of the additions. In a typical design with, for example, 4096 pulses per distance measurement, this means an improved SNR by a factor of 64.

Unfortunately, digital signal processing often also creates interference signals that occur synchronously with the sampling clock and therefore do not increase with the square root like statistically distributed noise, but rather linearly with the number of additions, i.e. the number of emitted light pulses, like the useful signal. This means that from a certain number of additions, these synchronous interferences dominate over the noise and there is no further improvement in the SNR if the number of pulses is increased, since the synchronous interferences, like the noise, worsen the SNR.

### SUMMARY OF THE INVENTION

It is therefore an object of the invention to provide a method by which the influence of the synchronous interference on the measurement result can be reduced or eliminated.

### BRIEF DESCRIPTION OF DRAWINGS

FIG. 1 shows schematically the sequence of a distance measurement according to the prior art.

FIG. 2 shows a histogram of a distance measurement.

FIG. 3 shows a histogram of a further distance measurement.

FIG. 4 shows a sampling histogram.

FIG. 5 an interference histogram.

FIG. 6 a distance histogram.

### DETAILED DESCRIPTION OF THE INVENTION

According to the invention, in a method of the type mentioned at the outset, an interference histogram is subtracted from the sampling histogram, thereby a distance histogram is obtained. The wanted distance to the object can then be determined from the distance histogram. The interference histogram preferably has the same length, i.e. the same number of samples, as the sampling histogram and represents the synchronous interference. By subtracting the interference histogram from the sampling histogram based on the measured values, the undesirable influence of synchronous interference can be reduced or, ideally, completely eliminated. When subtracting, the values of the interference histogram located at a temporal position are subtracted from the corresponding values of the sampling histogram. The values reflect the signal strength at the respective time.

The sampling histogram is obtained, for example, in a manner known per se by sending out light pulses through a transmitter, receiving the reflected light pulses using a receiver, for example an avalanche photodiode, and evaluating the received light pulses. The received light pulses are preferably amplified in an amplifier and then converted into digital signals in an A/D converter (analog-digital converter) before they are evaluated. These digital signals are then arranged in a sampling histogram.

The sending of the light pulses and/or the starting of the sampling clock by the A/D converter is preferably triggered (started) by the clock signal of a microcontroller.

The interference histogram can be found or determined in various ways.

A first possibility is to record a histogram of the same number of additions as in the distance measurement before the distance measurement, i.e. in particular before the light pulses are sent, but without triggering the transmitter of the rangefinder. The signals caused by the background light are received and evaluated by the rangefinder receiver. This histogram contains the same synchronous interference signal as that generated during distance measurement, only without the useful signal resulting from the target echo during distance measurement. It is therefore preferably provided that the interference histogram is determined before the light pulses are emitted.

The disadvantage of this method is that this interference histogram is just as noisy as the one recorded during the distance measurement, but the noise signals do not compensate for each other when the interference histogram is subtracted from the sampling histogram, since they occur statistically. On the contrary, the resulting noise will have a factor √2 higher RMS value, reducing the signal-to-noise ratio and disturbing the measurement result.

It is therefore preferred that the interference histogram has more summations than the sampling histogram. Therefore, more individual values are recorded and further processed by the receiver per time point in the histogram than per time point during the measurement process. Since no light pulses are emitted in this step, which is carried out before the actual measurement, but only samples are carried out by the receiver of the rangefinder, this is not relevant to the eye safety of the laser and a large number of samples can be carried out. At most, the length of time of this process, which takes place before the actual distance measurement, plays a role, since more time is required to obtain more summations. The interference histogram preferably has at least twice as many, particularly preferably at least four times as many, summations as the sampling histogram. For example, if you choose 4,096 summations for the distance measurement (corresponds to 4,096 laser pulses) and 16,384 summations for the interference histogram, the noise only increases by a factor of ½*√5, i.e. by approx. 12%. The length of the histograms remains the same.

In order to reduce the time required before the actual distance measurement, it is therefore preferably provided that the interference histogram is determined after at least one light pulse has been emitted.

It is particularly preferably provided that values of the sampling histogram are used to determine the interference histogram. In this embodiment, the interference histogram is calculated from the sample values determined during the distance measurement. This procedure is possible if the synchronous interference is repetitive and the period of the interference is known. The advantage of this method is that no sampling needs to be carried out before the actual measurement, so the overall duration of the procedure is comparatively shorter. If the period duration is n distance windows, in order to calculate the value of the 1^{st} distance window of the interference histogram, add to the sample value of the 1st distance window of the sampling histogram the 1+n^{th} sample value, the 1+2 n^{th} sample value, etc. until the end of the histogram; to calculate the value of the 2^{nd} distance window of the interference histogram, add to the sample value of the 2^{nd} distance window of the sampling histogram the 2+n^{th} sample value etc. up to the n+n^{th} distance window. From the n+1^{st} distance window, the compensation signal repeats itself. In this embodiment, the resulting noise of the interference histogram is only slightly higher than that of the sampling histogram. The useful signal will generally change the interference histogram somewhat, but to a manageable extent. The prerequisite is that the period n is small compared to the total length of the histogram, i.e. that the synchronous interference signal repeats itself frequently in the histogram, for example 10 times or more. The histogram recorded for distance measurement consists, for example, of 400 distance windows at a maximum measuring distance of 3000 m and a sampling rate of 20 MHz. The period of the interferences is typically 8 or 16. This means that the requirement of a short period compared to the histogram length is usually met. Furthermore, the smaller it is, the smaller is the distorting influence of the useful signal (target pulse) on the interference histogram and thus on the distance histogram. The method according to the invention is particularly effective especially with small useful signals.

In other words, this preferred method can be represented as follows:

$${b}_{1} = ( {a}_{1} + {a}_{1 + n} + {a}_{1 + 2 n} + … {+}_{a 1 + n \cdot ( k - 1 )} ) / k = {b}_{1 + n} = {b}_{1 + 2 n} = … = {b}_{1 + n \cdot ( k - 1 )}$$

$${b}_{2} = ( {a}_{2} + {a}_{2 + n} + {a}_{2 + 2 n} + … + {a}_{2 + n \cdot ( k - 1 )} ) / k = {b}_{2 + n} = {b}_{2 + 2 n} = … = {b}_{2 + n \cdot ( k - 1 )}$$

$$etc ,$$

where n is the period of the interference, k is the number of repetitions of the interference in the histogram and n·k is the length of the histogram.

a₁ etc. are the values from the sampling histogram and b₁ etc. are the values from the interference histogram. The value a₁ is the value of the first sample, the value a₂ is the value of the second sample, etc.

It is preferably provided that the interference histogram is periodic with a period that is an integer multiple of the sampling interval.

A laser diode is preferably used as the transmitter of the rangefinder. An avalanche photodiode (avalanche photodiode or APD) is preferably used as the receiver of the rangefinder. Both the transmitter and the receiver each have associated electronic circuits. Avalanche photodiodes are diodes with an internal amplification mechanism, making them capable of detecting even weak optical signal strengths and even single photons.

According to the invention, a device of the type mentioned at the outset is further provided, which is designed to carry out the method according to the invention and comprises at least a transmitter, a receiver, in particular an avalanche photodiode, and an amplifier.

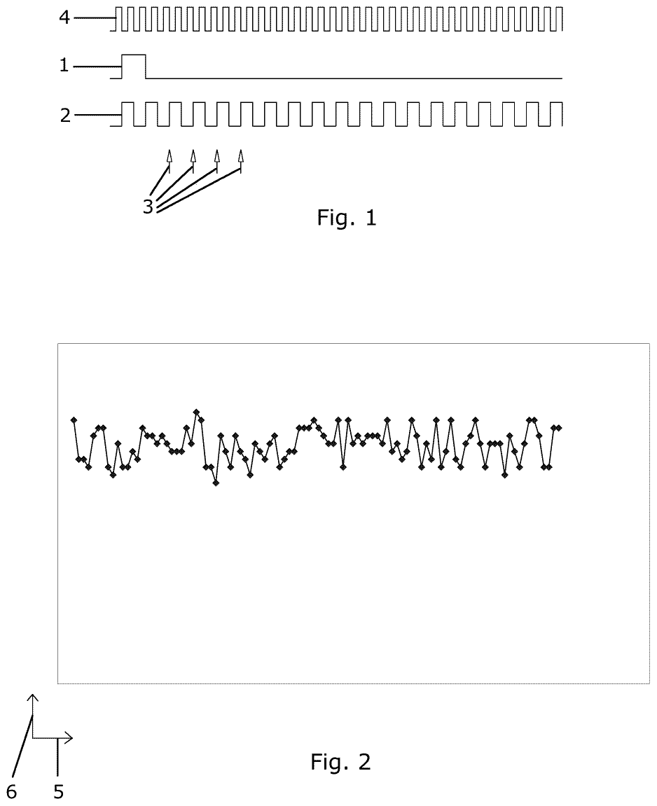

FIG. 1 shows the process of a distance measurement according to the prior art. 1 shows a light pulse that is emitted from the location in the direction of an object using a transmitter. At the same time as the light pulse 1 is emitted, a sampling 2 is started at a defined frequency by an A/D converter in order to read out the values received by a receiver, for example an avalanche photodiode. At the points 3 of the sampling, sample values of the emitted and reflected light pulses 1 are determined and further processed. Each sample value corresponds to a specific distance from the location. After a defined period of time, the sampling is ended and then a light pulse 1 is sent out again and a new sampling 2 is started. This procedure is usually carried out several times to get a better result. The sample values obtained are summed up and then displayed, for example, in a histogram. In order to start the light pulse 1 and the sampling at the same time, a microcontroller with a clock signal 4 is provided, which triggers or starts both the light pulse 1 and the sampling 2.

In FIG. 2 the result of a measurement with a single light pulse 1 is shown in the form of a histogram. The time is plotted in the direction of the x-axis 5 and the received signal strength is plotted in the direction of the y-axis 6. The measured values sampled by the A/D converter show no trace of a received target reflex.

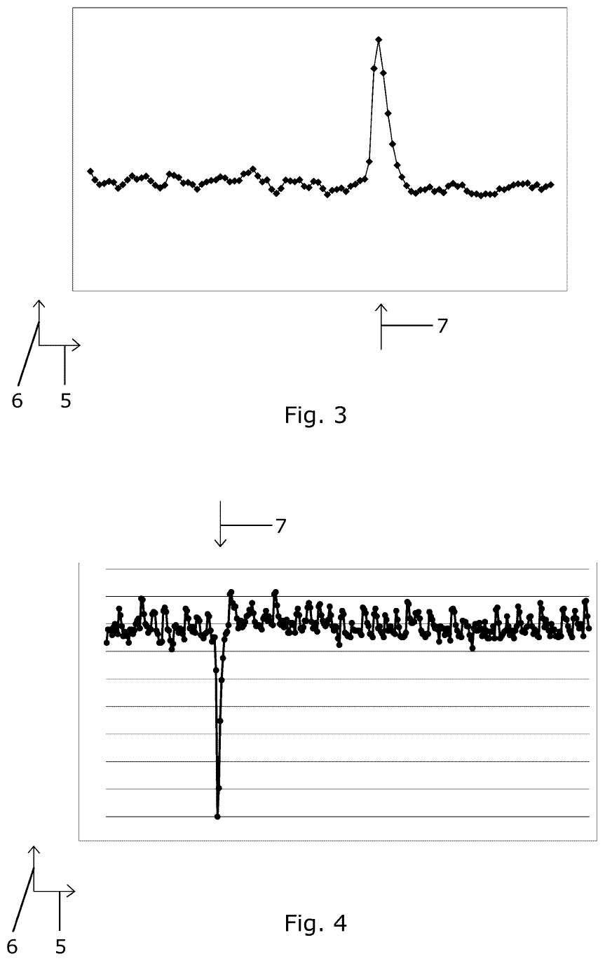

FIG. 3 shows the result of a measurement with several thousand light pulses 1, with the individual sample values being summed up. The values of the individual light pulses that were detected at the same sampling times are added together. Each point therefore corresponds to the sum of the signals received at a sampling cycle during the sampling interval. A significantly stronger signal can be seen in area 7. The distance to the target object can now be calculated from the temporal position of the maximum in area 7 in the direction of x-axis 5, which indicates the time period after which the signal was received, and the size of the signal strength in the y-direction 6, for example by interpolating the 50% point of the rising or falling edge of the pulse or by the position of the center of gravity of the pulse.

FIG. 4 shows a sampling histogram that was determined during the implementation of a method according to the invention. In contrast to the illustration according to FIG. 3, the maximum signal runs downwards in the y direction and not upwards, since the signal was inverted by the amplification. It can be seen that in area 7 a maximum signal was measured in the direction of the y-axis 6 (signal strength), which was obtained by reflected and received light pulses 1 and indicates the distance to the target object. In the other areas along the x-axis 5 (time), signals with lower signal strength were measured, which are made up of noise and synchronous interference.

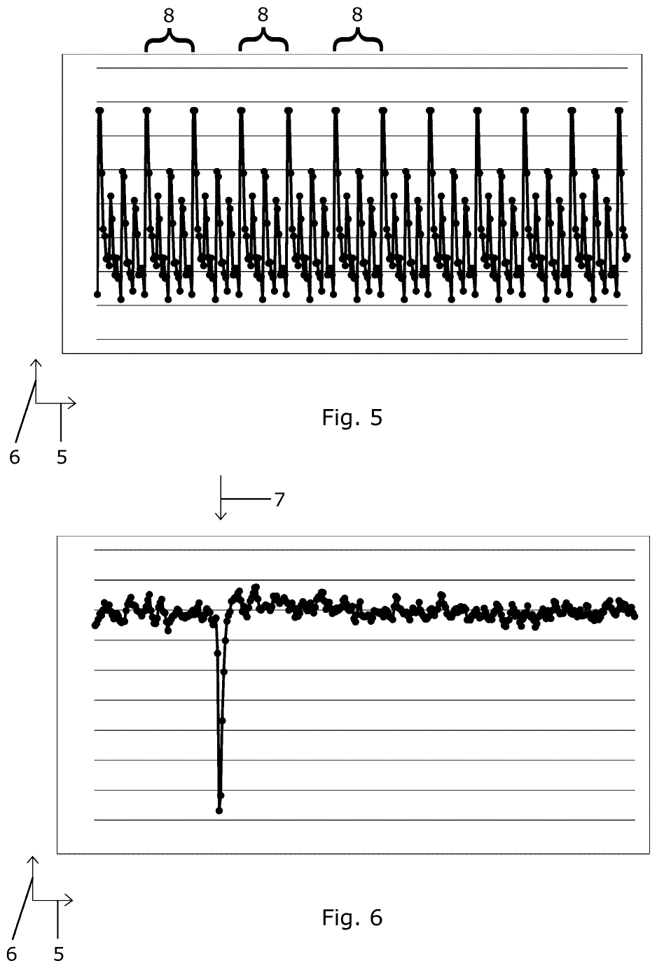

In FIG. 5, an interference histogram is shown. This interference histogram shows the existing synchronous interference and can either be determined before the actual measurement using the rangefinder or can be calculated from the sampling histogram during the distance measurement. It is clearly visible that the synchronous interferences 8 repeat themselves periodically.

FIG. 6 shows a distance histogram which was determined by a combination of the sampling histogram (FIG. 4) and the interference histogram (FIG. 5) in order to remove the synchronous interference from the sampling histogram. The respective values of the interference histogram were subtracted from the corresponding values of the sampling histogram. It can be clearly seen that the values in the distance histogram outside area 7 have a significantly smaller bandwidth than in the sampling histogram and a better signal-to-noise ratio was achieved, which enables a more precise measurement of the distance to the target object.

1. A method for measuring the distance between a location and an object, in which several light pulses are emitted from the location and the light pulses reflected by the object are sampled, whereby sample values are obtained which are summarized in a sampling histogram, characterized in that an interference histogram is subtracted from the sampling histogram, thereby a distance histogram is obtained.

2. The method according to claim 1, wherein the interference histogram is determined before the light pulses are transmitted.

3. The method according to claim 1, wherein the interference histogram has more summations than the sampling histogram.

4. The method according to claim 1, wherein the interference histogram is determined after at least one light pulse has been emitted.

5. The method according to claim 4, wherein values of the sampling histogram are used to determine the interference histogram.

6. The method according to claim 4, wherein the interference histogram is calculated as follows:
$${b}_{1} = ( {a}_{1} + {a}_{1 + n} + {a}_{1 + 2 n} + … + {a}_{1 + n \cdot ( k - 1 )} ) / k = {b}_{1 + n} = {b}_{1 + 2 n} = … = {b}_{1 + n \cdot ( k - 1 )}$$
$${b}_{2} = ( {a}_{2} + {a}_{2 + n} + {a}_{2 + 2 n} + … + {a}_{2 + n \cdot ( k - 1 )} ) / k = {b}_{2 + n} = {b}_{2 + 2 n} = … = {b}_{2 + n \cdot ( k - 1 )}$$
$$etc ,$$
where n is the period of the interference, k is the number of repetitions of the interference in the histogram, n·k is the length of the histogram and a1 etc. are the values from the sampling histogram and b1 etc. are the values from the interference histogram.

7. The method according to claim 4, wherein the interference histogram is periodic with a period that is an integer multiple of the sampling interval.

8. A device for measuring the distance between a location and an object for carrying out a method according to claim 1, comprising at least a transmitter, a receiver and an amplifier.
